(19) United States
(12) Patent Application Publication
(10) Pub. No.: US 2012/0273457 A1
(43) Pub. Date: Nov. 1, 2012

(54) THIN FILM PATTERNING METHOD

(75) Inventors: Shigeru Kido, Mobara-shi (JP); Nobuhiko Sato, Mobara-shi (JP); Tomoyuki Hiroki, Mobara-shi (JP); Kenji Ookubo, Mobara-shi (JP); Nozomu Izumi, Chiba-shi (JP)

(73) Assignee: CANON KABUSHIKI KAISHA, Tokyo (JP)

(21) Appl. No.: 13/448,642

(22) Filed: Apr. 17, 2012

(30) Foreign Application Priority Data
Apr. 28, 2011 (JP) 2011-101675

(51) Int. Cl. B32B 38/10; B44C 1/22

(52) U.S. Cl. 216/36; 156/247

(57) ABSTRACT

Provided is a thin film patterning method for patterning a thin film made of one of inorganic, organic, and organic/inorganic materials provided on a first substrate including: forming and patterning a thin film made of a material A on the first substrate; forming a thin film made of a material B, which is one of inorganic, organic, and organic/inorganic materials, on the first substrate and on the thin film; bonding the thin film, which is formed on the thin film, to a second substrate, thereby laminating the first substrate and the second substrate together to produce a laminated substrate; and removing the thin film and the thin film, which is provided on the thin film, from the first substrate.

### BACKGROUND OF THE INVENTION

1. Field of the Invention

The present invention relates to a thin film patterning method in which a thin film made of an inorganic, organic, or organic/inorganic material is processed into a desired shape.

2. Description of the Related Art

As a method of patterning a thin film formed on a substrate into a desired shape, for example, a method using photolithography is known. Specifically, a photoresist layer is formed on a thin film in a region intended to be patterned, and the photoresist layer is subjected to etching after exposure and development. This process can leave the thin film formed on the substrate only at a desired position/region.

Patterning of a thin film using photolithography is a widely used method for patterning a thin film made of an inorganic material. Patterning of a thin film made of an organic material, on the other hand, involves a problem that the organic material constituting the thin film is affected by an organic solvent used as a solvent for photoresist. Specifically, there is a problem that, if the solvent for photoresist contacts the organic material constituting the thin film, an organic material intended to be left is also dissolved.

The same problem applies to a developer used after exposure of a photoresist film and a stripper for stripping a resist after etching. As an exposure liquid and a developer, a tetramethylammonium hydroxide (TMAH) solution is typically used. As a stripper, on the other hand, a mixed solution of hydroxylamine, 2-(2-aminoethoxy)ethanol, catechol, and water (sometimes referred to as EKC) is typically used. In some cases, the organic material constituting the thin film is soluble in those solutions. This is an obstacle for the use of photolithography.

Aimed at solving the problem in the patterning process using photolithography, particularly inherent in a thin film made of an organic material, namely the problem that a film intended to be left is dissolved during the process, a method described in Japanese Patent No. 4557285 is proposed, for example. The method of Japanese Patent No. 4557285 includes the step of forming and patterning a film made of a water-soluble material onto a substrate by photolithography, the step of forming a thin film on the substrate or on the film made of the water-soluble material, and the step of removing the film made of the water-soluble material by lift-off. The method proposed in Japanese Patent No. 4557285 is a thin film patterning method utilizing the difference between solubility of a photoresist in water and solubility of a water-soluble material in an organic solvent and utilizing selective lift-off.

However, in the method of Japanese Patent No. 4557285, when a patterning member such as a photoresist which has finished its role in thin film processing and has no longer been required or a material to be lifted-off such as a thin film formed on the patterning member is removed, such member may adhere onto the substrate again. If such member intended to be removed adheres onto the substrate again, a patterning failure occurs.

### SUMMARY OF THE INVENTION

The present invention has been made for solving the above-mentioned problem. It is an object of the present invention to provide a thin film patterning method capable of avoiding a patterning member, which has finished its role in thin film processing, and a thin film formed on the patterning member from adhering onto a substrate again.

According to an exemplary embodiment of the present invention, there is provided a method for patterning a thin film made of one of inorganic, organic, and organic/inorganic materials provided on a first substrate, including; forming and patterning a thin film made of a material A on the first substrate, forming a thin film made of a material B, which is one of inorganic, organic, and organic/inorganic materials, on the first substrate and on the thin film made of the material A, bonding the thin film made of the material B, which is formed on the thin film made of the material A, to a second substrate, thereby laminating the first substrate and the second substrate together to produce a laminated substrate; and removing the thin film made of the material A and the thin film made of the material B, which is provided on the thin film made of the material A, from the first substrate.

According to the present invention, it is possible to provide the thin film patterning method capable of avoiding the patterning member, which has finished its role in thin film processing, and the thin film formed on the patterning member from adhering onto the substrate again.

Further features of the present invention will become apparent from the following description of exemplary embodiments with reference to the attached drawings.

### BRIEF DESCRIPTION OF THE DRAWINGS

FIGS. 1A, 1B, 1C, and 1D are schematic cross-sectional views illustrating a thin film patterning method according to a first embodiment of the present invention.

FIG. 2 is a schematic cross-sectional view illustrating one suitable example of the first embodiment of the present invention.

FIGS. 3A, 3B, 3C, and 3D are schematic cross-sectional views illustrating a thin film patterning method according to a second embodiment of the present invention.

FIG. 4 is a schematic cross-sectional view illustrating one suitable example of the second embodiment of the present invention.

FIGS. 5A, 5B, 5C, 5D, 5E, and 5F are schematic cross-sectional views illustrating a process of manufacturing an organic EL display device according to Example 4 of the present invention.

FIGS. 6A, 6B, 6C, 6D, 6E, and 6F are schematic cross-sectional views illustrating a process of manufacturing a tungsten contact plug according to Example 5 of the present invention.

### DESCRIPTION OF THE EMBODIMENTS

A method of the present invention is a method of patterning a thin film made of an inorganic, organic, or organic/inorganic material provided on a first substrate. As described below, the thin film patterning method of the present invention has two kinds of aspects.

The thin film patterning method according to a first aspect of the present invention includes the following steps (Ia) to (IVa); (Ia) forming and patterning a thin film made of a material A on a first substrate, (IIa) forming a thin film made of a material B, being an inorganic, organic, or organic/inorganic material, on the first substrate and on the thin film made of the material A, (IIIa) bonding the thin film made of the material B formed on the thin film made of the material A to a second substrate, thereby laminating the first substrate and the second substrate together to produce a laminated substrate, and (IVa) removing the thin film made of the material A and the thin film made of the material B provided on the thin film made of the material A from the first substrate.

The thin film patterning method according to a second aspect of the present invention includes the following steps (Ib) to (IVb); (Ib) forming and patterning a laminate including at least a thin film made of a material A1 and a thin film made of a material A2 on a first substrate, (IIb) forming a thin film made of a material B, being an inorganic, organic, or organic/inorganic material, on the first substrate and on the laminate, (IIIb) bonding the thin film made of the material B formed on the laminate to a surface of a second substrate, thereby laminating the first substrate and the second substrate together to produce a laminated substrate, and (IVb) removing the laminate and the thin film made of the material B provided on the laminate from the first substrate.

Note that, in the thin film patterning method according to the second aspect of the present invention, at least the thin film made of the material A2 is a layer made of a material which is insoluble in any of water, an organic solvent, and a mixed solvent of water and an organic solvent.

Hereinafter, embodiments of the present invention are described with reference to the drawings. Note that, well-known or publicly-known technologies in the art of the present invention are applicable to portions that are not particularly illustrated or described herein. Further, the embodiments herein are merely an embodiment of the present invention and the present invention is not intended to be limited to the embodiments.

FIGS. 1A to 1D are schematic cross-sectional views illustrating a thin film patterning method according to a first embodiment of the present invention. Hereinafter, respective steps are described with reference to FIGS. 1A to 1D as appropriate.

(Ia) Step of Patterning Thin Film Made of a Material A

At first, as illustrated in FIG. 1A, a thin film 11 made of a material A (hereinafter, sometimes referred to simply as “thin film 11”) is formed and patterned on a first substrate 1.

The material A as a constituent material of the thin film 11 is not particularly limited as long as a lift-off step described below can be performed without any difficulty. The material A may be made of one kind of material or multiple kinds of materials. The material A, however, needs to be selected from a material having higher solubility in a specific solvent than that of a material B described below. This selection of material enables the thin film 11 made of the material A to be selectively removed from the first substrate 1 with the use of the specific solvent in the lift-off step described below.

Note that, the material A described above needs to be selected appropriately in accordance with the material B. Hereinafter, specific examples of the material selection are described.

For example, in the case where the material B is a water-insoluble material such as an organic material, a water-soluble material is selected as the material A. If the material A is made of multiple kinds of materials, it is sufficient that a part of the constituent materials be a water-soluble material. When a water-soluble material is selected as the material A, it is preferred to use water as a solvent (solution for dissolving the material A) in the lift-off step described below.

Exemplary water-soluble materials selected as the material A include water-soluble inorganic materials, such as LiF and NaCl, and water-soluble polymers, such as polyvinyl alcohol and polyvinylpyrrolidone. The present invention, however, is not limited thereto.

In the case where the material B is insoluble or hardly-soluble in alcohols (methanol, ethanol, isopropyl alcohol, etc.), a heterocyclic compound is selected as the material A. Examples of the heterocyclic compound selected as the material A include a heterocyclic compound containing phenanthroline and a heterocyclic compound containing pyridine. More specifically, a compound represented by the following structural formula is exemplified.

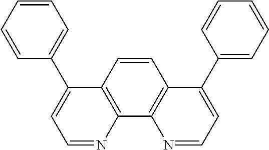

In the heterocyclic compound, charge is localized at an element other than carbon (N, S, O, or the like). For example, negative charge on pyridine, which is a heterocyclic compound, is localized at the nitrogen element of the ring. This polar part and a hydrogen atom in an OH group of an alcohol molecule interact with each other to form a hydrogen bond. The hydrogen bond allows the heterocyclic compound to be easily dissolved in alcohols. Thus, the heterocyclic compound having polarity has a high dissolution rate in alcohol.

In light of the above, the material A can be selected as appropriate in consideration of the properties of the material B, specifically, the solubility of the material B in a specific solvent. In other words, the material B is selected from a material which is insoluble in a solvent for dissolving the material A to be used in the lift-off step described below. Note that, the specific solvent is not limited to water and alcohols described above and is not particularly limited as long as the solvent satisfies the condition of not dissolving the film made of the material B which is a target of patterning.

In the case where the solvent for dissolving the material A is water, a water-insoluble material, which is insoluble in water, is selected as the material B. Examples of the water-insoluble material include an organic material, being insoluble in water, an inorganic material, a hybrid material made of an organic material and an inorganic material in combination, and a mixed material of an organic material and an inorganic material. Examples of the inorganic material include silicon compounds, such as oxide silicon and nitride silicon, and a metal which is insoluble in water and non-reactive to water. The present invention, however, is not limited thereto.

In the case where the solvent for dissolving the material A is alcohols containing a hydroxyl group, such as methanol, ethanol, and isopropyl alcohol, a material which is hardly-soluble in the alcohols is selected as the material B. An example of the material which is hardly-soluble in the alcohols includes an aromatic hydrocarbon compound. Examples of the aromatic hydrocarbon compound include ones each containing, as a main skeleton, a condensed polycyclic hydrocarbon compound such as naphthalene, fluoranthene, anthracene, tetracene, phenanthrene, pyrene, triphenylene, or chrysene.

The term “condensed polycyclic hydrocarbon compound” as used herein refers to an unsaturated cyclic organic compound formed of hydrocarbon only, and specifically, refers to a compound containing a condensed ring in which at least one side of aromatic rings (e.g. benzene rings) are condensed. Further, the condensed polycyclic hydrocarbon compound does not have polarity because II electrons are delocalized equally on the condensed ring. Thus, the condensed polycyclic hydrocarbon compound is a material which is hardly soluble in alcohol.

However, the above-mentioned condensed polycyclic hydrocarbon compound has naturally low thermal stability and is therefore unsuitable as the constituent material of the thin film 12 made of the material B. Thus, a compound in which a substituent is added to such condensed polycyclic hydrocarbon compound is used as the constituent material of the thin film 12 made of the material B.

As the compound used as the constituent material of the thin layer 12 (uppermost layer thereof in a case where the layer 12 is a laminate including multiple layers) made of the material B, an organic compound in which multiple condensed polycyclic hydrocarbon compounds described above are singly bonded to each other is preferred. Moreover, the organic compound includes a compound in which the main skeleton (condensed polycyclic hydrocarbon compound) is substituted as appropriate with an alkyl group such as a methyl group or an ethyl group. Further, the organic compound does not include a compound having a hetero atom (N, O, or the like) in the main skeleton or in a substituent.

An example of the organic compound in which the multiple condensed polycyclic hydrocarbon compounds are singly bonded includes a compound represented by the following structural formula. The present invention, however, is not limited thereto.

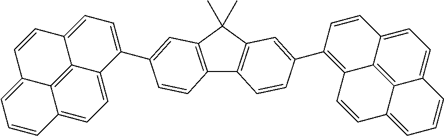

By the way, the method of patterning the thin film made of the material A may be photolithography, ink jetting, printing, and other similar methods. In the case of using photolithography, first, it is necessary to form the thin film 11 made of the material A on the entire surface of a substrate (first substrate 1). As the method of forming the thin film 11 made of the material A, an existing method such as chemical vapor deposition (CVD), vapor deposition, spin coating, dip coating, and ink jetting can be used. After the thin film 11 made of the material A is formed on the entire surface of the substrate (first substrate 1), the formed thin film 11 made of the material A is patterned. Specifically, a photoresist film is applied and formed on the thin film 11 made of the material A, followed by exposure and development steps, and the thin film 11 made of the material A provided in a region not covered with the photoresist film is removed by etching (wet etching or dry etching). In this manner, the thin film 11 made of the material A, which has been patterned into a desired shape as illustrated in FIG. 1A, can be formed.

Note that, the use of photolithography is accompanied by the use of an organic solvent as a solvent for dissolving a photoresist, and hence, during the patterning of the thin film 11 made of the material A, the material A itself may dissolve. In this case, it is preferred to employ ink jetting or printing. Specifically, a solution containing the material A is selectively applied at a predetermined position or region. In this manner, the thin film 11 made of the material A, which has been patterned into a desired shape as illustrated in FIG. 1A, can be formed.

(IIa) Step of Forming Thin Film Made of Material B

After the above-mentioned step (Ia), as illustrated in FIG. 1B, a thin film 12 made of a material B (hereinafter, sometimes referred to simply as “thin film 12”) is formed on the first substrate 1 or on the thin film 11 made of the material A.

As the method of forming the thin film 12 made of the material B, an existing method such as chemical vapor deposition (CVD), vapor deposition, spin coating, dip coating, and ink jetting can be used.

Note that, the main feature of the present invention is that the thin film 11 made of the material A disposed on the first substrate 1 and the thin film 12 made of the material B formed on the thin film 11 are removed from the first substrate 1 with the use of a second substrate 2 bonded onto the thin film 12. It is therefore preferred that the thin film 11 made of the material A be structured to be easily removable from the first substrate 1.

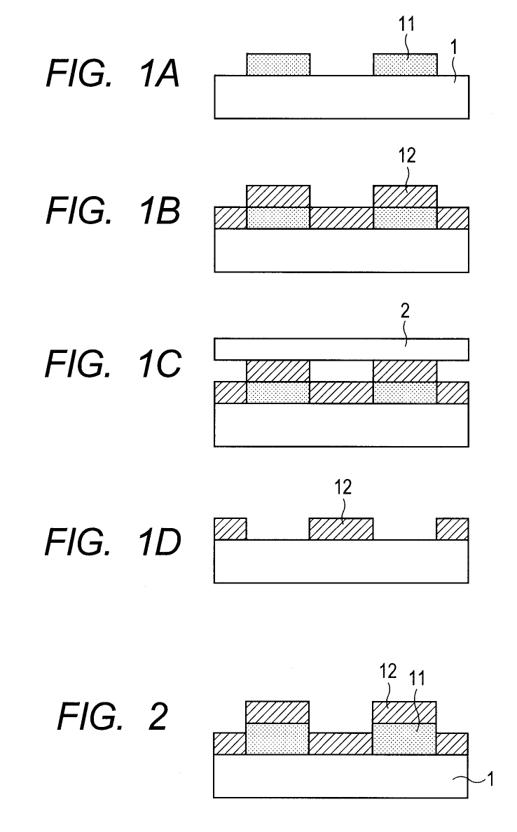

FIG. 2 is a view illustrating one suitable example of the present invention. As illustrated in FIG. 2, it is preferred that the thin film 11 made of the material A and the thin film 12 made of the material B be formed on the first substrate 1 so that the thin film 11 made of the material A may be thicker than the thin film 12 made of the material B. In other words, it is preferred to form the thin film 11 made of the material A so that the thin film 12 made of the material B may be thinner than the thin film 11. This makes it easier for a solvent for dissolving the material A to contact the end portion of the thin film 11 made of the material A, thus enabling patterning at high yields.

(IIIa) Step of Producing Laminated Substrate

After the above-mentioned step (IIa), as illustrated in FIG. 1C, the thin film 12 made of the material B and the second substrate 2 are laminated together, thereby producing a laminated substrate formed of the first substrate 1 and the second substrate 2.

The surface of the second substrate 2 used in this step needs to be able to bond to the thin film 12 made of the material B formed on the thin film 11 made of the material A provided on the first substrate 1.

The second substrate 2 is not particularly limited as long as the substrate is made of a material which is insoluble in a solvent for dissolving the thin film made of the material A. Specific examples of the second substrate 2 include, but are not limited to, a silicon wafer, a glass substrate, and an organic resin sheet such as a PET resin sheet and an acrylic resin sheet.

In order to enhance the adhesiveness between the second substrate 2 and the thin film 12 made of the material B, an adhesive layer (not shown) may be formed on the surface of the second substrate 2 in advance. The adhesive layer may be formed by laminating an adhesive sheet or by applying a material of an adhesive onto the surface of the second substrate 2. Specific examples of the material of the adhesive layer include a thermosetting polymer resin, an epoxy resin based adhesive, and a reactive acrylic adhesive. The present invention, however, is not limited thereto.

On the other hand, as a specific method in this step of laminating the first substrate 1 and the second substrate 2 together to produce a laminated substrate, an existing method such as an adhesive lamination method and a method of activating the substrate surface can be used. The present invention, however, is not particularly limited thereto.

(IVa) Lift-Off Step

After the above-mentioned step (IIIa), the second substrate 2 is moved, and the thin film 11 made of the material A is removed from the first substrate 1 together with or simultaneously with the thin film 12 made of the material B formed on the thin film 11. In this manner, as illustrated in FIG. 1D, the thin film 12 made of the material B is left only in a desired region, thereby patterning the thin film 12 made of the material B into a desired shape.

This step is a step of removing the thin film 11 made of the material A provided on the first substrate 1 from the first substrate 1 at the interface between the first substrate 1 and the thin film 11 made of the material A or in the vicinity of the interface. Examples of the method of removing the thin film 11 made of the material A include a mechanical method, a chemical method, and a thermal method. The present invention, however, is not particularly limited thereto.

In the case of the mechanical method, the adhesive strength at the interface between the first substrate 1 and the thin film 11 made of the material A is reduced in advance to be lower than the adhesive strength at the interface between the thin film 11 made of the material A and the thin film 12 made of the material B and at the interface between the thin film 12 made of the material B and the second substrate 2. With this, through application of a force in the direction of separating the first substrate 1 or the second substrate 2 from the opposing substrate, the thin film 11 made of the material A can be removed from the first substrate 1.

In the case of the thermal method, the materials are selected so that the melting point or the softening point of the thin film 11 made of the material A may be lower than the melting point or the softening point of each of the first substrate 1, the thin film 12 made of the material B, and the second substrate 2. With this, through separation of the first substrate 1 or the second substrate 2 under application of heat to the laminated substrate, the thin film 11 made of the material A can be removed from the first substrate 1.

An example of the chemical method includes a method in which a solvent (solution) for selectively dissolving the thin film 11 made of the material A is caused to penetrate a gap provided between the first substrate 1 and the second substrate 2, to thereby dissolve the thin film 11 made of the material A. In other words, when the solvent for dissolving the thin film 11 made of the material A penetrates the thin film 11 made of the material A, the thin film 11 made of the material A dissolves. At this time, the thin film 12 made of the material B, which is formed on the thin film 11 made of the material A, is bonded onto the second substrate 2, and hence, when the first substrate 1 and the second substrate 2 are separated from each other, the thin film 12 made of the material B bonded on (the surface of) the second substrate 2 is separated from the first substrate 1. On the other hand, the thin film 12 made of the material B, which is directly formed on the first substrate 1 (formed so as to be in contact with the first substrate 1), is not bonded onto the second substrate 2, and the thin film 11 made of the material A is not present between the thin film 12 and the first substrate 1, and hence this thin film 12 is left on the first substrate 1 even after this step. Therefore, the thin film 12 made of the material B is patterned along a region other than the region in which the thin film 11 made of the material A, which was left after the step (Ia), was provided. Further, in this method (chemical method), the solvent penetrates also the interface between the first substrate 1 and the thin film made of the material A, and hence a residue of the material A is hardly left on the first substrate 1. In addition, in this method (chemical method), a residue of the material B or the like generated in this step is collected by the second substrate 2, and hence the residue is never left on the first substrate 1.

Of the above-mentioned methods (mechanical method, thermal method, and chemical method), it is preferred to employ the chemical method, in consideration of the finishing state of the patterned thin film 12 made of the material B after this step.

Note that, in the case of using the chemical method, the method of causing a solvent for dissolving the thin film 11 made of the material A to penetrate a gap between the laminated two substrates is not particularly limited as long as the solvent can penetrate the inside of the gap between the two substrates forming the laminated substrate.

A specific method thereof is a method in which, after the laminated substrate is placed in a chamber under a reduced pressure atmosphere whose pressure is lower than atmospheric pressure, a solvent for dissolving the material A is introduced in the chamber and the pressure in the chamber is sequentially varied to cause the solvent to penetrate.

The solvent used in this step is appropriately selected from any one of water, an organic solvent, and a mixed solvent of water and an organic solvent in consideration of the properties of the material A, especially the solubility of the material A.

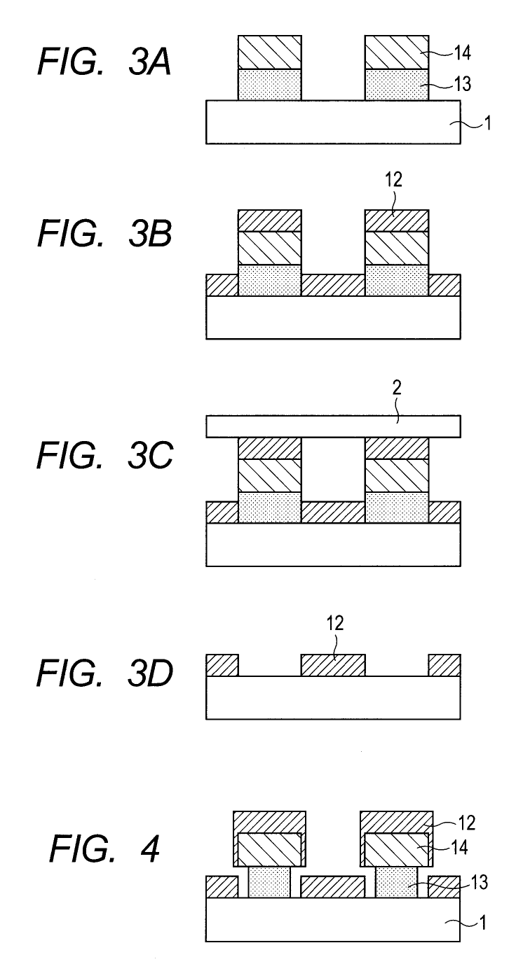

FIGS. 3A to 3D are schematic cross-sectional views illustrating a thin film patterning method according to a second embodiment of the present invention. Hereinafter, respective steps are described with reference to FIGS. 3A to 3D as appropriate. Note that, the second embodiment is partially in common with the first embodiment and hence the difference from the first embodiment is mainly described below.

(Step of Forming Laminate)

At first, as illustrated in FIG. 3A, a laminate formed of a thin film 13 made of a material A1 (hereinafter, sometimes referred to simply as “thin film 13”) and a thin film 14 made of a material A2 (hereinafter, sometimes referred to simply as “thin film 14”) is formed on the first substrate 1.

As illustrated in FIG. 3A, the present invention may use, instead of using the thin film 11 made of the material A, the laminate formed of the thin film 13 made of the material A1 and the thin film 14 made of the material A2. In the first embodiment of the present invention, when photolithography is used for patterning of the thin film 11 made of the material A, there is a case where the material A constituting the thin film 11 is suitable for the lift-off step but unsuitable for photolithography. As countermeasures, in this embodiment, the laminate formed of the thin film 13 made of the material A1 and the thin film 14 made of the material A2 is used, instead of using the thin film 11. The use of this laminate enables the use of a material suitable for the lift-off step as the material A1, which is the constituent material of the thin film 13, and the use of a material suitable for photolithography as the material A2, which is the constituent material of the thin film 14. For example, a water-soluble material is used as the material A1 constituting the thin film 13 (under layer) and a water-insoluble material is used as the material A2 constituting the thin film 14 (upper layer). Specifically, a water-soluble polymer can be selected as the material A1 to form the thin film 13 and a water-insoluble inorganic material such as silicon nitride can be selected as the material A2 to form the thin film 14. With this configuration, for example, even when the material A1 is a material susceptible to a solvent for photoresist used in the photolithography step, the surface thereof is protected by the material A2 and therefore the photolithography step can be performed without any problem.

In the second embodiment of the present invention illustrated in FIGS. 3A to 3D, it is preferred to form the thin film 13 to be thicker than the thin film 12. This makes it easier for a solvent for dissolving the material A1 to contact the end portion of the thin film 13 made of the material A1, thus enabling patterning at high yields.

(Step of Patterning Laminate)

Subsequently, the laminate formed of the thin film 13 and the thin film 14 is patterned. For the patterning of the laminate, photolithography is used. In this embodiment (second embodiment), an exemplary aspect for the patterning of the thin film 13 and the thin film 14 is described below. FIG. 4 is a schematic cross-sectional view illustrating one suitable example of the second embodiment of the present invention. As illustrated in FIG. 4, the end portion of the thin film 13 made of the material A1 is shaped to be positioned inward with respect to the end portion of the thin film 14 made of the material A2. Accordingly, in forming the thin film 12, the thin film 12 hardly adheres onto the end portion of the thin film 13, with the result that the thin film 13 remains exposed. When a solvent for dissolving the thin film 13 made of the material A1 is caused to penetrate, the solvent can easily contact the end portion of the thin film 13, which solves the problem of a peeling failure caused if the thin film 12 made of the material B is formed at the end portion of the thin film 13. Therefore, the dissolution rate of the thin film 13 is increased, thereby enabling patterning more efficiently at high yields.

(Other Steps)

After the laminate formed of the thin film 13 and the thin film 14 is patterned in the manner described above, the thin film 12 made of the material B is formed on the first substrate 1 and on the laminate formed of the thin film 13 and the thin film 14 (FIG. 3B). Subsequently, the first substrate 1 and the second substrate 2 are laminated together to produce a laminated substrate (FIG. 3C). Subsequently, a lift-off step is performed, to thereby pattern the thin film 12 made of the material B along a region other than the region in which the laminate formed of the thin film 13 and the thin film 14, which was left after the step of patterning the laminate, was provided (FIG. 3D).

The steps from FIG. 3A to FIG. 3D (the step of forming the thin film 12 made of the material B, the step of producing the laminated substrate, and the lift-off step) can be performed with the same methods as in the first embodiment.

The thin film patterning method of the present invention is effective for manufacturing a thin film shaped device or an electronic device including a thin film shaped member. For example, the thin film patterning method is effective for forming an electrode layer or an organic compound layer constituting an organic EL element. The thin film patterning method is also effective for manufacturing a thin film shaped semiconductor device such as a thin film transistor (TFT) or a contact plug.

### EXAMPLE 1

According to the steps illustrated in FIGS. 1A to 1D, the thin film 12 patterned into a desired shape was produced on the first substrate 1.

(Ia) Step of Forming and Patterning Thin Film made of a Material A

In Example 1, polyvinylpyrrolidone (PVP), being a water-soluble material, was used as the material A. Specifically, ink jetting was performed to apply and form the material A on the first substrate 1, thereby forming the thin film 11. The thickness of the thin film 11 at this time was 1 μm. Note that, the thin film 11 was formed on the first substrate 1 in a region in which the thin film 12 made of the material B described below was not to be provided.

(IIa) Step of Forming Thin Film Made of Material B

In Example 1, silicon nitride, being a water-insoluble material, was used as the material B. Specifically, physical vapor deposition (PVD) was performed to form a silicon nitride film on the first substrate 1 or on the thin film 11 made of the material A. The thickness of the thin film 12 at this time was 0.5 μm.

(IIIa) Step of Producing Laminated Substrate

A glass substrate was prepared as the second substrate 2. On the second substrate 2, a thermosetting polymer (such as photoresist) was applied to form a film thereof by a spin coater. The thickness of the thin film made of the thermosetting polymer at this time was 500 nm. Subsequently, an adhesive was applied on the thin film made of the thermosetting polymer, and the first substrate 1 and the second substrate 2 were laminated together, thereby producing a laminated substrate. Note that, it is not always necessary to form a thermosetting polymer film but it is preferred to provide a thermosetting polymer between the glass substrate and the adhesive because, when the second substrate 2 is cleaned by a stripper for the thermosetting polymer, deposits on the second substrate 2 can be removed and the second substrate 2 can therefore be reused.

(IVa) Lift-Off Step

Subsequently, the laminated substrate produced in the step (IIIa) was immersed into water to dissolve the thin film 11 so that the second substrate 2 was separated from the first substrate 1, thereby removing the thin film 12 bonded on the second substrate 2 together with the thin film 11.

Through the process described above, the thin film 12 made of the material B patterned into a desired shape was formed on the first substrate 1.

### EXAMPLE 2

A compound represented by the following structural formula [1] and a compound represented by the following structural formula [2] were used as the material A and the material B of Example 1, respectively.

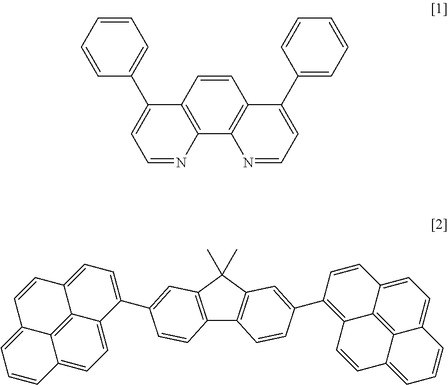

A mixed solvent prepared by mixing isopropyl alcohol and water was used in the lift-off step (IVa) of Example 1. Using the same method as in Example 1 except for the above, a thin film made of a material B was patterned.

Through the process described above, similarly to Example 1, the thin film 12 made of the material B patterned into a desired shape was formed on the first substrate 1.

### EXAMPLE 3

According to the steps illustrated in FIGS. 3A to 3D, the thin film 12 patterned into a desired shape was produced on the first substrate 1.

(Step of Forming Laminate)

First, by spin coating, a PVP film was formed on the first substrate 1 to form the thin film 13 made of the material A1. The thickness of the thin film 13 at this time was 1 μm. Subsequently, by chemical vapor deposition (CVD), a silicon nitride (SiN) film was formed on the thin film 13 to form the thin film 14 made of the material A2. The thickness of the thin film 14 at this time was 0.5 μm.

(Step of Patterning Laminate)

Subsequently, the laminate formed of the thin film 13 and the thin film 14 provided on the first substrate 1 was patterned by photolithography. First, a positive photosensitive resin was applied on the thin film 14 to form a photosensitive resin film. Subsequently, an exposure device (trade name: MPA600, manufactured by Canon Inc.) was used to irradiate the photosensitive resin film with ultraviolet rays. This irradiation of ultraviolet rays was performed via a photomask having an opening provided in a desired region (region in which the laminate formed of the thin film 13 and the thin film 14 was to be removed). Following the exposure, development was performed using a developer (trade name: “312MIF”, manufactured by AZ Electronic Materials, diluted with water to a concentration of 50%). Through this development treatment, the photosensitive resin film which had been exposed to ultraviolet rays was removed. Subsequently, the laminate formed of the thin film 13 and the thin film 14 was subjected to etching treatment in a region not covered with the photosensitive resin film, thereby obtaining a laminate formed of the thin film 13 and the thin film 14, which was patterned into a desired shape.

(Step of Forming Thin Film Made of Material B)

Using a similar method to the step (IIa) of Example 1, the thin film 12 made of the material B was formed.

(Step of Producing Laminated Substrate)

Using a similar method to the step (IIIa) of Example 1, a laminated substrate was produced.

(Lift-Off Step)

Using a similar method to the step (IVa) of Example 1, lift-off was performed to remove the thin film bonded on the second substrate 2 together with the laminate formed of the thin film 13 and the thin film 14.

Through the process described above, similarly to Example 1, the thin film 12 made of the material B patterned into a desired shape was formed on the first substrate 1.

### EXAMPLE 4

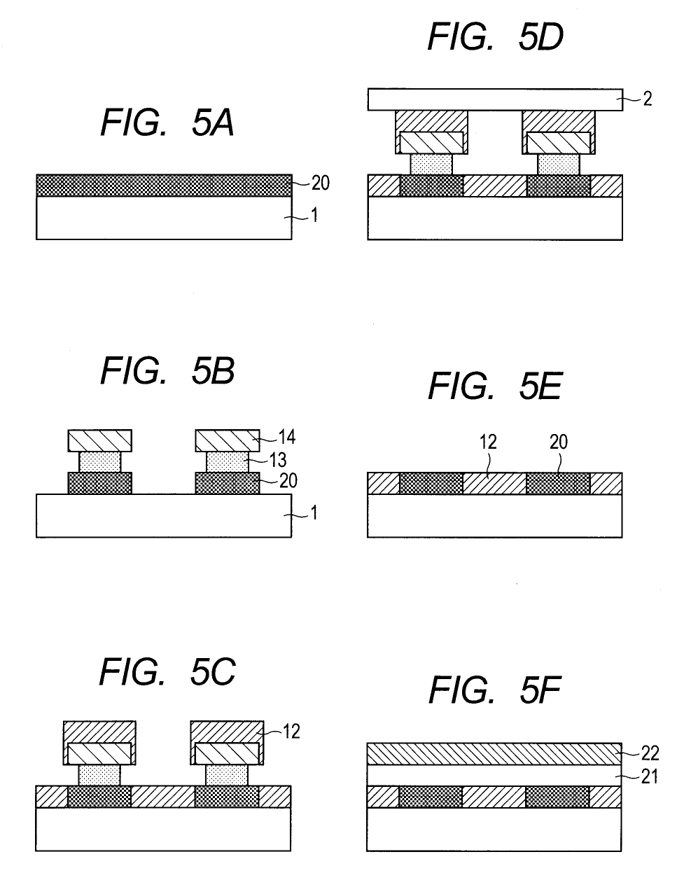

An organic EL display device including two kinds of organic EL elements having different emission colors was manufactured by the following method. FIGS. 5A to 5F are schematic cross-sectional views illustrating a process of manufacturing an organic EL display device according to Example 4 of the present invention.

(Step of Forming First Organic Compound Layer)

On a substrate (first substrate 1) on which TFTs and lower electrodes were provided in advance, a first hole transport layer and a first emission layer were sequentially formed, thereby forming a first organic compound layer 20 (FIG. 5A).

(Step of Processing First Organic Compound Layer)

Subsequently, by spin coating, a PVP film was formed on the first organic compound layer 20 to form the thin film 13 made of the material A1. The thickness of the thin film 13 at this time was 1 μm. Subsequently, by chemical vapor deposition (CVD), a silicon nitride (SiN) film was formed on the thin film 13 to form the thin film 14 made of the material A2. The thickness of the thin film 14 at this time was 0.5 μm.

Subsequently, the laminate formed of the thin film 13 and the thin film 14 provided on the first organic compound layer 20 was patterned by photolithography. First, a positive photosensitive resin was applied on the thin film 14 to form a photosensitive resin film (photoresist film). Subsequently, an exposure device (trade name: MPA600, manufactured by Canon Inc.) was used to irradiate the photosensitive resin film with ultraviolet rays. This irradiation of ultraviolet rays was performed via a photomask having an opening provided in a region other than a region in which a first organic EL element was to be provided (i.e., in a region in which the laminate formed of the thin film 13 the thin film 14 was to be removed). Following the exposure, development was performed using a developer (trade name: “312MIF”, manufactured by AZ Electronic Materials, diluted with water to a concentration of 50%). Through this development treatment, the photosensitive resin film which had been exposed to ultraviolet rays was removed. Subsequently, the laminate formed of the thin film 13 and the thin film 14 was subjected to etching treatment in a region not covered with the photosensitive resin film, thereby obtaining a laminate formed of the thin film 13 and the thin film 14, which was patterned in the region in which the first organic EL element was to be provided. Note that, the thin film 13 was subjected to etching treatment so as to be over-etched as compared with etching of the thin film 14.

Subsequently, the first organic compound layer 20 was subjected to dry etching, thereby removing the first organic compound layer 20 provided in the region other than the region in which the first organic EL element was to be provided (FIG. 5B).

(Step of Forming Second Organic Compound Layer)

Subsequently, by vapor deposition, a second hole transport layer and a second emission layer constituting a second organic EL element were sequentially formed, thereby forming a second organic compound layer. Note that, the second organic compound layer corresponds to the thin film 12 made of the material B illustrated in FIG. 5C. Note that, in Example 4, the thin film 12 made of the material B, which is a thin film made of an organic compound, is formed by vapor deposition. In general, in the case of forming a thin film by vapor deposition, the thin film is formed to have a shape illustrated in FIG. 5C because of linearity of molecules. That is, the thin film 12 has a cross-sectional shape in which cuts are made in advance by the laminate formed of the thin film 13 and the thin film 14.

(Step of Producing Laminated Substrate)

Subsequently, a glass substrate was prepared as the second substrate 2. On the second substrate 2, a thermosetting polymer was applied to form a film thereof by a spin coater. The thickness of the thin film made of the thermosetting polymer at this time was 500 nm. Subsequently, an adhesive was applied on the thin film made of the thermosetting polymer, and the first substrate 1 and the second substrate 2 were laminated together, thereby producing a laminated substrate (FIG. 5D).

(Lift-Off Step)

Subsequently, the laminated substrate produced earlier was immersed into water to dissolve the thin film 13 so that the second substrate 2 was separated from the first substrate 1, thereby removing the thin film 12 bonded on the second substrate 2 together with the laminate formed of the thin film 13 and the thin film 14.

Through the process described above, the thin film 12 (second organic compound layer) made of the material B patterned into a desired shape was formed on the first substrate 1 (FIG. 5E).

(Step of Forming Upper Electrode, etc.)

Subsequently, an electron transport layer 21 and an upper electrode 22 were sequentially formed on the first organic compound layer and the second organic compound layer. In this way, an organic EL display device in which the two kinds of organic EL elements for emitting different colors of light were provided was obtained (FIG. 5F).

### EXAMPLE 5

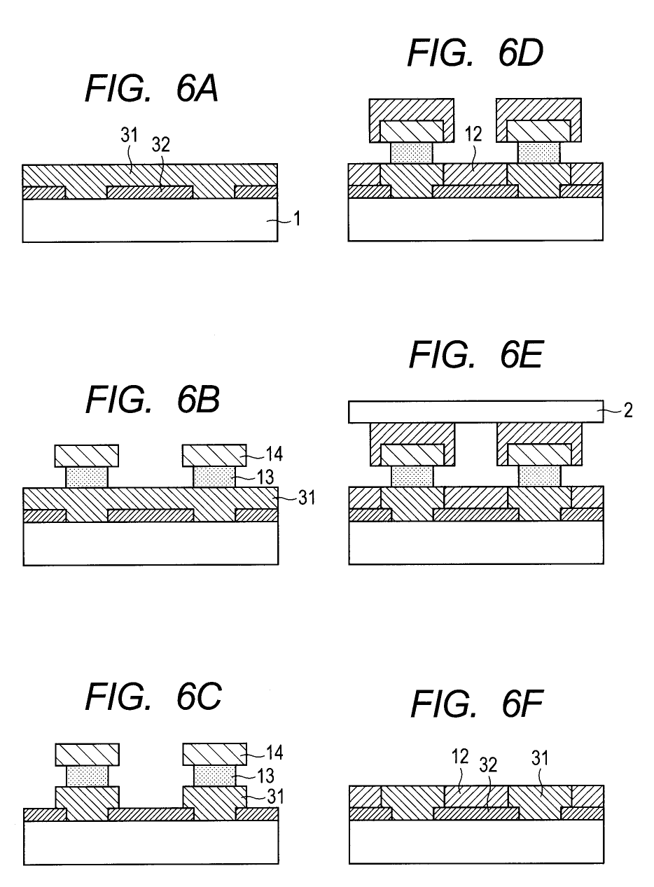

A tungsten contact plug (W contact plug) was manufactured by the following method. FIGS. 6A to 6F are schematic cross-sectional views illustrating a process of manufacturing a tungsten contact plug according to Example 5 of the present invention. By the way, in the manufacture of a W contact plug, W etch back or W chemical mechanical polish (W_CMP) is used. In any of the methods, however, a method of depositing a thick tungsten film (W film) and grinding the W film thereafter is used, and it is therefore necessary to form the W film to be thicker by a thickness which is unnecessary for the element itself. On the other hand, when the following method of Example 5 is used, it is only necessary to form a W film having a thickness large enough to fill a desired hole diameter of a contact plug portion.

(Step of Processing Silicon Oxide Film)

A first substrate 1 was prepared, in which metal wiring 32 was provided in predetermined regions and a silicon oxide film 31 was formed on the entire substrate surface including the metal wiring 32 (FIG. 6A). The silicon oxide film 31 was then processed by the following method.

First, by spin coating, a PVP film was formed on the silicon oxide film 31 to form the thin film 13 made of the material A1. The thickness of the thin film 13 at this time was 1 μm. Subsequently, by chemical vapor deposition (CVD), a silicon nitride (SiN) film was formed on the thin film 13 to form the thin film 14 made of the material A2. The thickness of the thin film 14 at this time was 0.5 μm.

Subsequently, the laminate formed of the thin film 13 and the thin film 14 provided on the silicon oxide film 31 was patterned by photolithography. First, a positive photosensitive resin was applied on the thin film 14 to form a photosensitive resin film. Subsequently, an exposure device (trade name: MPA600, manufactured by Canon Inc.) was used to irradiate the photosensitive resin film with ultraviolet rays. This irradiation of ultraviolet rays was performed via a photomask having an opening provided in a region in which the W contact plug was to be provided (i.e., in a region in which the laminate formed of the thin film 13 the thin film 14 was to be removed). Following the exposure, development was performed using a developer (trade name: “312MIF”, manufactured by AZ Electronic Materials, diluted with water to a concentration of 50%). Through this development treatment, the photosensitive resin film which had been exposed to ultraviolet rays was removed. Subsequently, the laminate formed of the thin film 13 and the thin film 14 was subjected to etching treatment in a region not covered with the photosensitive resin film, thereby obtaining a laminate formed of the thin film 13 and the thin film 14, which was patterned in the desired region (FIG. 6B). Note that, the thin film 13 was subjected to etching treatment so as to be over-etched as compared with etching of the thin film 14.

Subsequently, the silicon oxide film 31 was subjected to dry etching, thereby removing the silicon oxide film 31 provided in the region in which the W contact plug was to be provided (FIG. 6C).

(Step of Forming W Film)

Subsequently, a tungsten film was formed by vapor deposition, thereby forming a W film. Note that, the W film corresponds to the thin film 12 made of the material B illustrated in FIG. 6D. Note that, the W film formed in this step has a shape illustrated in FIG. 6D. That is, the thin film 12 has a cross-sectional shape in which cuts are made in advance by the laminate formed of the thin film 13 and the thin film 14.

(Step of Producing Laminated Substrate)

Subsequently, a glass substrate was prepared as the second substrate 2. On the second substrate 2, a thermosetting polymer was applied to form a film thereof by a spin coater. The thickness of the thin film made of the thermosetting polymer at this time was 500 nm. Subsequently, an adhesive was applied on the thin film made of the thermosetting polymer, and the first substrate 1 and the second substrate 2 were laminated together, thereby producing a laminated substrate (FIG. 6E).

(Lift-Off Step)

Subsequently, the laminated substrate produced earlier was immersed into water to dissolve the thin film 13 so that the second substrate 2 was separated from the first substrate 1, thereby removing the thin film 12 bonded on the second substrate 2 together with the laminate formed of the thin film 13 and the thin film 14.

Through the process described above, the thin film 12 (W film) made of the material B patterned into a desired shape was formed on the first substrate 1 (FIG. 6F). That is, through the above-mentioned steps, the W contact plug was formed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-101675, filed Apr. 28, 2011, which is hereby incorporated by reference herein in its entirety.

What is claimed is:

1. A method for patterning a thin film provided on a first substrate, comprising:
forming a patterned thin film made of a material A on the first substrate;
forming a thin film made of a material B on the first substrate and on the thin film made of the material A;
bonding the thin film made of the material B, which is formed on the thin film made of the material A, to a second substrate; and
removing the thin film made of the material B, which is bonded on the second substrate, and the thin film made of the material A from the first substrate.

2. The method according to claim 1, wherein the removing of the thin film made of the material B, which is bonded on the second substrate, and the thin film made of the material A from the first substrate comprises bringing one of water, an organic solvent, and a mixed solvent of water and an organic solvent into contact with the material A, which is provided on the first substrate, to selectively dissolve and remove at least a part of the thin film made of the material A.

3. The method according to claim 1, wherein the thin film made of the material A is formed to be thicker than the thin film made of the material B.

4. The method according to claim 2, wherein the forming of the patterned thin film made of the material A on the first substrate comprises:
forming a thin film made of a material A1 on the first substrate, the material A1 being soluble in any one of water, an organic solvent, and a mixed solvent of water and an organic solvent; and
forming a thin film made of a material A2 on the thin film made of the material A1, the material A2 being insoluble in any of water, an organic solvent, and a mixed solvent of water and an organic solvent.

5. The method according to claim 4, wherein the forming of the patterned thin film made of the material A on the first substrate comprises forming the thin film made of the material A1 so that an end portion of the thin film made of the material A1 is shaped to be positioned inward with respect to an end portion of the thin film made of the material A2.

6. A method of manufacturing an organic electroluminescence display device, comprising patterning an organic compound layer with use of the method according to claim 1.
